(19) United States
(12) Patent Application Publication
(10) Pub. No.: US 2007/0064120 A1
(43) Pub. Date: Mar. 22, 2007

(54) Chroma-key event photography

(76) Inventors: Richard Didow, Tomball, TX (US); Robert Bryant JR., Houston, TX (US)

Correspondence Address: LAW OFFICE OF DAVID MCEWING, P.O. BOX 231324, HOUSTON, TX, 77023, US

(21) Appl. No.: 11/228,930

(22) Filed: Sep. 16, 2005

(51) Int. Cl. H04N 5/235

(52) U.S. Cl. 348/229.1

(57) ABSTRACT

The invention comprises an entertaining digital chroma-key video photography event (“photo event”) wherein at least one photo subject is placed in front of a green screen background. The participant is photographed while moving or speaking in response to verbal prompts or from viewing action in a simultaneously shown interactive composite of the participant with the substitute and moving background. The participant may be provided with a still photo produced from the video or photographed simultaneously with the video. The participant may view or retrieve the full video or additional still photos by logging onto an Internet website, intranet or other computer network. The invention also comprises use of multiple substitute images wherein there may be at least a substitute background and a substitute foreground. The image of the participant appears in the resulting composite as variably being in an intermediate position, the foreground or background. The invention also comprises a method of surveying individuals. The individuals responding to survey questions may be participants of the photo event or others, e.g., the parents of adolescent children. The individual are prompted to respond in exchange for or at the time of receipt of the video or photo.

### BACKGROUND OF THE INVENTION

1. Field of Use

This invention relates to a method of creating event still photos or videos using chroma-key technology. The photo event process may be conducted for entertainment and the resulting photos and videos can be used for entertainment and souvenirs or mementos. The photos or videos may be provided to participants in exchange for participation in information surveys or similar activities.

2. Related Art

Event photography is known. It comprises photographing individuals or small groups that are attending events such as sporting events, holiday parties, festivals, amusement parks, etc. Event photography may be entertaining. The photo subjects may stand in front of a background depicting any number of locations or events. The photo subjects may be positioned next to a life size photo of a famous individual. The photo subject may, for example, appear to be standing next to a U.S. President or standing next to a famous individual such as Albert Einstein.

Another variation is to have the photo subjects stand in front of a “green screen” (or “blue screen”) and using known chroma-key photo techniques, a substitute background is inserted into a resulting composite photograph. This chroma-key technique is often used with still photography but motion photography or video is also known.

Chroma-key composite still photography techniques achieve a composite photo depicting the photo subject to be standing in the midst of a football game, a crashing wave of water or similar fanciful scenario.

The resulting photo is provided to the participant, i.e., it may be alternately sold to the photo participant or provided for free by a sponsor of the photo event, perhaps with the sponsor's name or product depicted in the photo or on a photo folder sleeve in which the photo or video may be inserted. The resulting photo or video may also be made accessible to the participant via an Internet connection where the photo or video may be viewed, downloaded or further distributed by the participant to others. In some variations, the photo is made available to the photo subject without cost but after the photo subject answers questions or participates in a survey offered by the sponsor. In other variations, responding to a survey or questionnaire is not required. This variation wherein the photo subject elects, in a separate step, to log on to an Internet site to view or retrieve the photos and perhaps to answer questions or view, for example, sponsor product or service information, may be termed “logging in”.

Recently, use of chroma-key photography has been combined with motion photography to provide an entertaining “dance head”. This technique includes placing the photo subjects in front of a green screen, draping green fabric over the shoulders and torso of the photo subjects who also sit on tall stools behind a green screen foreground. The green screen foreground covers the legs of the photo subjects from the view of the camera. The resulting effect is that, upon subtraction of the green screen using chroma-key techniques, only the heads of the photo subjects are visible to the camera and a substitute background and foreground may be inserted. (Note that since only the heads of the photo subjects are disclosed, portions of the single substitute image may appear to be variously in the background and foreground.) Music is played and the photo subjects are encouraged to bob their heads up and down in response to the music. The substitute image includes the legs, arms and torsos of other people dancing to the music. Alternatively, the substituted image can be of cartoons or caricature legs, arms and torsos. The photo subjects are provided a DVD or other video medium showing their heads dancing on the bodies of others. The DVD includes audio, i.e., the sound of the music. The DVD is provided at the photo event. The photo subjects do not have the opportunity to log onto a computer network to receive or distribute the video. The photo event is entertaining for the photo subjects and on-lookers. The creation of the DVD is, however, time consuming and limits the number of people that can participate within a given time period. There is also no interaction between the participants and the substituted image.

Video photography with audio has also been used to create personalized mementos or souvenirs of attendance at an event such as a football game or theme park. The photo subjects may stand in front of a painted or photo background and state that they are attending the event, having a good time, etc. The photo subjects may be provided a DVD of their presentation. The photo subjects may also retrieve or view their video by logging on to an Internet site. There is, however, no interaction with a substituted image.

Business is continuously looking for new and more effective marketing means. They also seek to learn of consumer preferences or habits. Use of surveys or test sampling are known. Each requires the locating willing participants to the survey or sampling event. One on one solicitation of volunteers can be expensive. Other types of broad appeal for participants are also problematic. Businesses seeking consumer input may be sponsors of the photo event, particularly when the step of logging onto a computer network is utilized.

### SUMMARY OF INVENTION

The present invention comprises an entertaining digital chroma-key video photography event (“photo event”) wherein at least one photo subject (“participant”) is placed in front of a chroma-key green screen background. The participant is photographed while moving or speaking (“interacting”) in response to verbal prompts or from viewing action in a simultaneously shown interactive composite of the participant with the substitute and moving background and/or foreground. The participant may be provided with a still photo produced from the video or photographed simultaneously with the video. The participant may view or retrieve the full video or additional still photos by logging onto an Internet website, intranet or other computer network.

The invention also comprises use of multiple substitute images wherein there may be at least a substitute background and a substitute foreground. The image of the participant appears in the resulting composite as variably being in an intermediate position, the foreground or background.

The invention also comprises a method of surveying individuals. The individuals (“response contributor”) responding to survey questions may be participants of the photo event or others, e.g., the parents of adolescent children. The individuals are prompted to respond in exchange for the video or photo. Response contributors may also be onlookers to the photo event.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates one prior art method wherein a picture is taken of the photo subject which can be provided, i.e., given or sold to the photo subject.

FIG. 2 illustrates the steps of a prior art method wherein the participant is photographed and the participant is given some means of accessing or logging into an Internet website to view, retrieve, share by email or purchase the photo or video.

FIG. 3 illustrates one embodiment of the present invention interactive photo event showing the participant interacting with the action of the substitute single (background) image.

FIG. 4 illustrates an embodiment of the invention incorporating a substitute background and a foreground image to be integrated with digital video of the participant with simultaneous display of the combined image to the participant.

FIGS. 5A and 5B illustrates an outline of a photo event video sequence of the type illustrated in FIG. 4 using a substitute background and a foreground image and optionally moving foreground images to the background or vice versa.

FIG. 6 illustrates an embodiment of the invention for integrating a background image and a foreground image with a video photographed element or participant.

### DETAILED DESCRIPTION OF THE INVENTION

The above general description and the following detailed description are merely illustrative of the subject invention and additional modes, advantages and particulars of this invention will be readily suggested to those skilled in the art without departing from the spirit and scope of the invention.

The invention utilizes advanced chroma-key digital photography techniques or technology wherein the photo subject (participant) interacts (moves or speaks) with another image (substitute image) and the image of the participant and substitute image are integrated and recorded as a single composite image. As used herein, the steps of integrating and recording multiple images into a single image is also termed rendering. A composite image is also termed a rendered image. Separate images (which may be stored on DVDs or separate computer files) may be combined and rendered into a single composite image.

Chroma-key photography includes the step of distinguishing the background from the foreground element (participant or object), typically by use of differing colors. The step often utilizes a strong vibrant colored background, e.g. a blue color screen or green color screen (“green screen”). At some point, the distinct color difference between the green screen background (presumed for purpose of explanation to be the green screen) and foreground element is used to remove or separate the foreground element(s) from the background. The color components of the visible background are removed from the entire photo image. Since the foreground element contains little of the background color component, there is little or no loss in the image of the foreground element. In digital photography, the separation of background from foreground element can be accomplished by subtracting the value of background color from each pixel of the image. This can be accomplished by several methods, including computer software.

The green screen background is replaced with a separate image (“substitute imag”) and which can be combined with the foreground element. The combination of images can be simultaneously displayed using a computer or composite image generator. The combination of the foreground element and substitute images can also be integrated or rendered into a single image or composite photo or video (hereinafter photo). Stated differently, where the software has subtracted the value of the background color, it can also then insert or substitute another value that in aggregate creates a new background scene.

It will be appreciated that the photo subject (“participant”) is positioned in front, i.e., foreground, of the green screen. The green screen surface displays a uniform color, the color components of which are recognizable and can be removed from the image without unsatisfactory degradation of the foreground element. The recognition and removal of the green screen color can be performed by a central processing unit (CPU) controlled software and equipment or composite image generator. This substitution of the green screen image can be performed in real time, thereby allowing the participant to see himself or herself “live” and combined with the substituted image. The participant can thereby react to action occurring within the substitute image. The photographed interaction of the participant can be recorded and integrated in a separate step to create an interactive composite image with the substitute image. The step of rendering includes recording of the integrated composite image. The composite image can be stored as a single computer file or recorded on a DVD or similar media. In the preferred embodiment, the video includes audio.

It will be appreciated that the substitute image may itself be a composite file or DVD from a combination of several images created with chroma-key technology. The substitute image can be prepared and digitally stored in advance of the photo event.

The ability to simultaneously photograph the participant and to substitute an image for the green screen (again typically the background) allows use of variable action backgrounds or action images with interaction by the participant. For example, one substitute image could show action occurring to the right of the participant. The action could be the sudden appearance of a large and perhaps frightening animal. It could alternatively be a running football player. Another substitute image could show action to the left of the participant. Again, the substitute image could show action occurring behind the participant. The use of variable and randomly selected images could add an element of surprise to the participant. This may be especially valuable and entertaining when there is an audience of viewers at the photography event, including some who may be waiting their turn as a participant.

In one embodiment, a CPU is used to display the combined multiple images in real time. The CPU records the photographed action of the participant and green screen and integrates and records (renders) a single composite image from the combination of separate images. This process utilizes commercially available photo editing software.

It will of course be appreciated that the chroma-key and green screen technique can be applied with a foreground. Such a foreground screen may thereby hide the legs of the participant from the camera.

Another novel use of chroma-key photography is integrating two or more substitute images with the photographed image of the participant. For example a foreground image and background image can be integrated with the participant shown as an interior or intermediate image or position. The background image can be created using a green screen as already discussed. Separate and multiple images (foreground, intermediate and background) can be integrated into a composite image using an integration module of a composite image generator. Commercially available software programs such as Ultra2 by Serious Magic of Folsum, Calif. may also perform this integration of the foreground, intermediate and background images.

A composite image generator may include a central processing unit (CPU) coupled to a data bus to a memory device and interface circuit. The memory device stores a software program that implements all or part of the functions of the integration module. The program is executed by the CPU. The memory device and/or separate database also store files, programs, web pages, etc. for use by the composite image generator.

One or more input devices may be connected to the interface circuit of the composite image generator. The devices may be used for entering commands into the CPU. Examples of such devices include computer mouse, keyboard, digital camera, etc. The composite image generator may also include output devices such as computer displays, printers, speakers, connected to the CPU via the interface circuit. The memory device may store integrated foreground and background images as discussed below. Preferably, a CPU having 933 Mhz or faster processing speed with an Intel Pentium III or 4 processor or equivalent and 512 MB RAM is used. Also preferred is a DVD-ROM drive and 1 GB available hard disk space with 32 MB AGP or PCI Express graphics card with 3D acceleration.

The image generator may also be connected to the Internet or other computer network, thereby allowing it to be positioned remotely from the photo event. Similarly, the digital camera located at the photo event may be connected to a CPU with a memory component and interface component connectable to a keyboard, computer mouse or other input device. The photo event CPU may also be in communication with the image generator by Internet or other computer network connection. Persons skilled in the technology will appreciate known connecting/interface components may be utilized, such as ethernet transceivers, digital subscriber line (DSL) or other high speed network connections. The CPU at the photo event will also store a software program that interacts with the image generator. The photo event CPU also will contain an output component including display drivers and printer drivers which will allow the composite image to be displayed and printed.

Persons skilled in the art will appreciate that other configurations of the CPUs and components are possible without departing from the spirit and scope of the invention. The foregoing is supplied as an example only.

Another embodiment of a composite image generator may consist of a video mixer or a time based corrector, such as a TBC 7000 from Data Video. The TBC 7000 utilizes a separate foreground DVD source and a background DVD source that each providing substitute images. The background and foreground images may be integrated and recorded with a separate photographed image of a participant. The rendered image may be displayed and stored to a DVD or computer.

The image generator operates in the following manner. The separate images are integrated by deleting or hiding pixels which are behind other pixels. Visible pixels in one layer cause pixels in the same position in a lower layer (background) to be hidden or deleted. Invisible (transparent) pixels of the foreground image do not cause pixels of the participant or background image to be hidden or deleted. For example, a digital image of the participant (intermediate image) standing at the intermediate position in front of the green screen background (background image) is captured. The system uses a large number of green pixels to find the outline of the participant. Pixels outside the outline of the participant are considered transparent. In other words, background image pixels are deleted wherever there is the participant in the intermediate image and background pixels remain wherever the green screen is captured in the intermediate image. In other words, the green pixels are removed and the background pixels of the substitute background image in the same position are kept for the composite image. Similarly, a foreground image with pixels predefined as transparent is created. For example, an image of a running football player may be shown in the foreground image with all other pixels from the foreground image being transparent to the intermediate image and the substitute background image. It will be appreciated that the foreground image can be created by placing the moving football player in front of a green screen and marking all green pixels of the digitally photographed image as transparent.

In one embodiment, the foreground and substitute background images are pre-stored within the memory of the image generator. Further, the foreground and background images may be pre-integrated or rendered, thereby reducing the time needed to create the composite image with the participant (intermediate) image.

As will be appreciated by persons skilled in the art, the three layers are combined and the integration module controls the creation of the composite image. The portion of the background image deleted is dependant on the foreground and intermediate (participant) images as described. The portion of the intermediate image deleted is determined by the foreground image. In the resulting composite image, the participant may appear to be standing or moving “behind” another object or person that may also be moving. Therefore the participant can be acting or reacting to action both in the foreground and in the background. This creates an interactive image. The combined action may be recorded in both motion photography, e.g., digital video, and in digital still photography. It will of course be appreciated that the camera is photographing the action of the participant in front of a green screen. The pre-stored digital images are then integrated into the composite image which may be recorded.

In one embodiment, the foreground image may be changed during a sequence to be marked transparent to the intermediate stage. For example, a football player may first appear in front of the participant but then stumble and fall to be then seen behind the participant. During the sequence, the participant maybe “running in place” in front of a green screen with a football field substituted as the background.

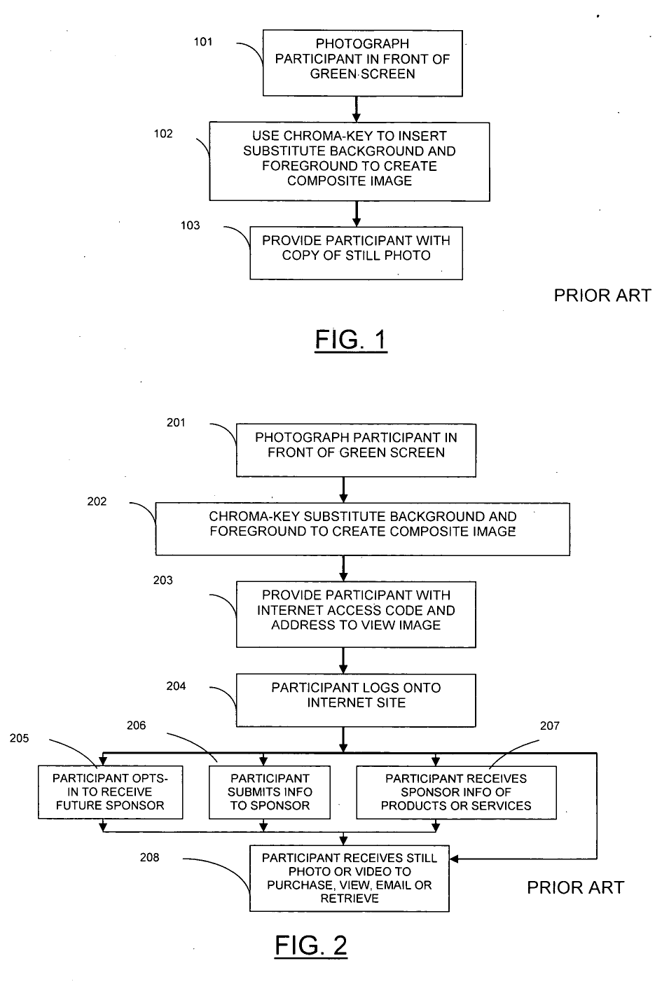

FIG. 1 illustrates an example of the prior art method of event photography. The participant is photographed 101 in front of a green screen. The substitute image is inserted using chroma-key technology 102. The participant is provided with a photo of the composite image 103.

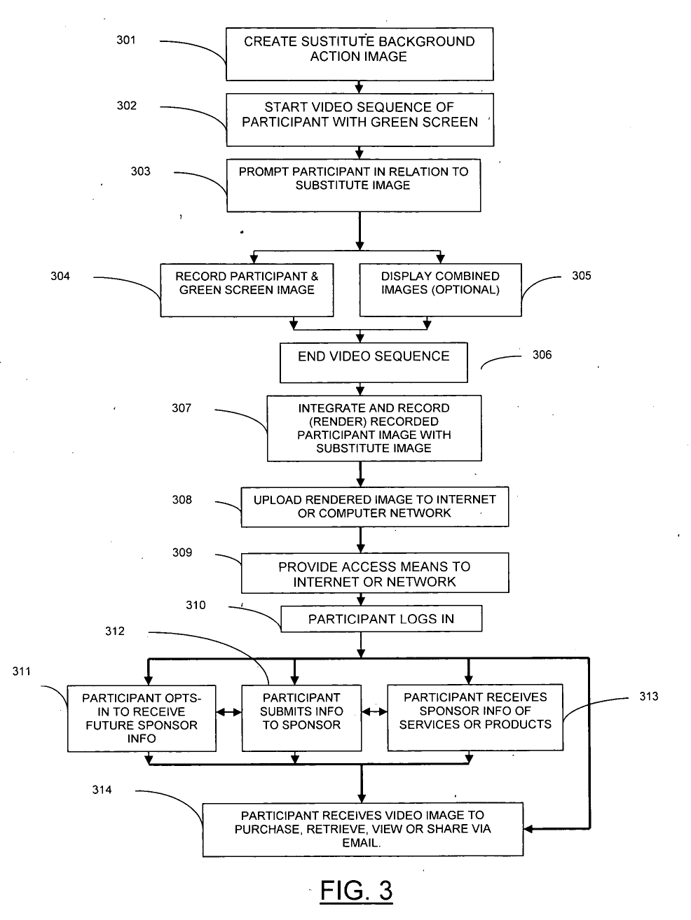

FIG. 2 illustrates another variation of the prior art. Again the participant is photographed in front of a green screen 201. Chroma-key technology is used to insert the substitute image for the green screen to create a composite image 202. The participant is provided with an Internet web site address and an access code which allows the participant to view the composite image 203. The participant may log on to the Internet site and enter the access code when prompted 204. The participant may be presented with an opportunity to “opt-in” 205 whereby the participant may receive future information or communications. The participant may, if prompted, submit information to the event sponsor 206 or, alternatively, receive information 207. The participant, by logging into the Internet site, receives the photo(s) or videos 208. As previously discussed, there is no interaction of the participant with the substitute image.

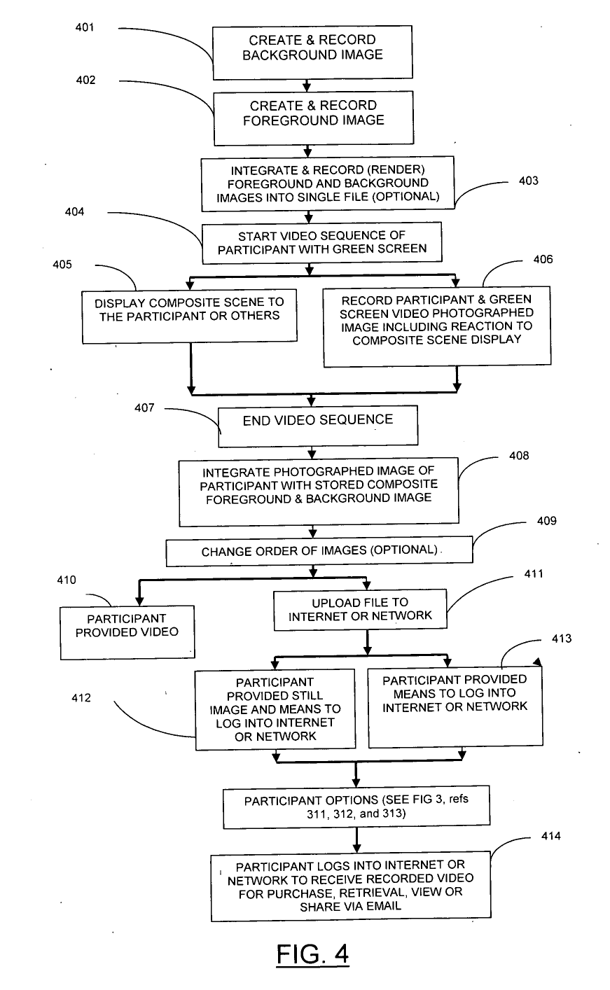

FIG. 3 illustrates one embodiment of a photo event subject of the present invention. It will be appreciated such event may be at a theme park, sporting event, a shopping mall, company picnic or holiday party, etc. A substitute image replaces the green screen using chroma-key technology 301. The substitute image may contain a border or frame that will appear in the “foreground” and contain the identity of the sponsor, the sponsor's product or service, the venue of the event, etc. It will be appreciated that the sponsor of the photo event may be a manufacturer of supplier of consumer products or services. The substitute image will contain objects of persons in motion or otherwise contain action that the participant may interact with. It will be appreciated that the substitute image itself can be the product of multiple images integrated into a single composite file created using chroma-key technology.

At the photo event, the digital video sequence begins with the participant being video photographed in front of a green screen 302. The participant is prompted to move or speak in response to action of the substitute image 303. The participant may be prompted by verbal commands or by observing a display containing the participant's image combined with the substitute image. It will be appreciated that the display of the combined image of the substitute image and the participant's interaction (response or reaction) occurs simultaneously with the continued video photographing 304, 305.

It will be appreciated that the combined images may be displayed 305 to the audience of onlookers at the photo event. The displayed combined images may be entertaining to the onlookers and will draw attention to the photo event and to the event sponsor. This attention may enhance the marketing of the sponsor's products or services or, as discussed, enhance participation in the collection of survey information.

The video sequence is ended 306. The multiple images, i.e., the videoed image of the participant and the pre-recorded background image, are also integrated and recorded (rendered) by a CPU 307 or other composite image generator hardware. The rendered image is then uploaded to an Internet or other computer network 308. The participant may be given means of accessing a computer network or Internet site to retrieve, view, purchase, or share by email the composite image 309. The means of access may include a URL and user name or password, etc. The participant elects to log onto a computer network or Internet web site 310. It will be appreciated that the computer network may include a kiosk located at the event location or elsewhere within the venue, e.g., elsewhere within the theme park or sports stadium where the photo event is located. Of course, if the Internet website may be accessed from the participant's home or hotel, etc.

The image may be the video or additionally include still photos created from the video or that are taken separately. In one variation (not shown) the means of access given to the participant at the end of the video sequence can include a still photo showing the combined image. Access information may be included or contained on the sleeve containing the still photo image. Being provided with a still photo may motivate the participant to log on to obtain access to the video or additional still photo. In yet another variation, the participant may create a still photo or image from the video. For example, a selected still image may be used as the “wall paper” of the participant's example, a selected still image may be used as the “wall paper” of the participant's computer “desktop”. an opportunity to “opt-in” 311 to receive future communications from the event sponsor an opportunity to “opt-in” 311 to receive future communications from the event sponsor or others. These communications may be of any form including email. The subject of the future communications could include but are not limited to special discounts and promotional offers for products or services.

The participant may be offered to submit information 312 such as demographic information of size of household, household income, location of residence, product or services used, product or service preferences or opinions or generally any type of survey or questionnaire response. This offer may be in addition to the opt-in offer.

The participant may be offered the opportunity to receive product or service information at the time of logging into the network or Internet 313. This may be information in the form of advertisement or “infomercial” such as information intended to enhance public goodwill of the sponsor. It will be appreciated that the participant may receive any or all of these offers. The participant will also be given the opportunity information in the form of advertisement or “infomercial” such as information intended to view or retrieve the video or still images 314. Retrieval of the images includes downloading the image. In the case of network kiosks, it may include the option of providing an email address or website of the participant to which the file containing the video or still photos may be forwarded. The retrieval of the image may be conditioned upon submission of a minimal quantity of information, such as the participant's name, email address or residence. The quantity or options of the image retrieval may be enhanced by participation in a survey questionnaire, etc.

In another variation (not illustrated), the participant may receive a DVD, VHS or other media containing the video image at the event location. In another variation, the members of the audience may also be solicited to participate in a survey or other data collection including opt-in opportunities.

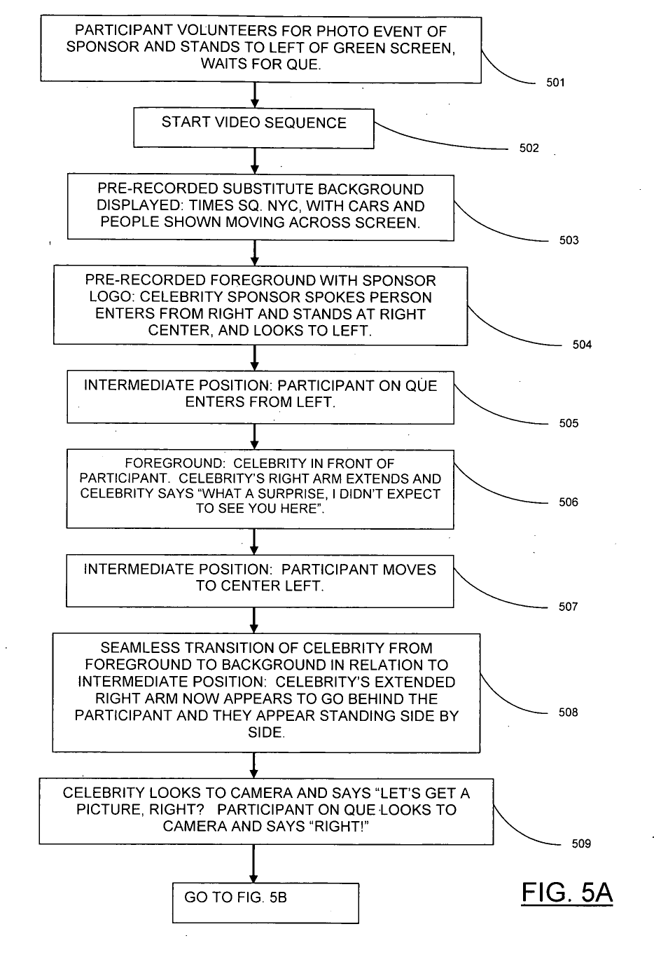

FIG. 4 illustrates yet another embodiment of the invention in which a plurality of separate pre-recorded action images can be combined with a videoed participant before a green screen. The invention permits two or more digital images to be used with the video of the participant in front of a green screen. A background is created 401, itself perhaps being a combination of images photographed before a green screen and then integrated and recorded. A foreground is also created 402. The ordering of the foreground and background has already been discussed.

In one variation of the invention depicted in FIG. 4, the foreground and background images may be integrated or rendered into a single digital file 403. This may economize the computing time required to combine the images with the videoed image for display. The digital foreground and background are stored (pre-recorded).

The video sequence of the participant with the green screen is started 404. The video image is displayed with the pre-recorded foreground and background 405. Simultaneously, the photographed image of the participant and green screen is recorded 406 by a CPU or composite image generator or similar device. The video sequence is ended 407. The combined images are integrated and recorded 408. The order of the images may be altered, i.e., the intermediate image of the participant can be brought to the foreground with the former foreground action now taking place behind the participant (but optionally in front of the continuing background) 409.

In the embodiment of the invention illustrated in FIG. 4, the participant may be provided with the recorded video 410. This video may be provided at the location of the photo event. Alternatively, the video may be uploaded to the Internet or other computer network 411. In one further embodiment, the participant may be provided with a still photo at the photo location with means to log into the Internet or network 412. As a further option the participant is provided with means to log onto the Internet or network 413. The participant has the option of logging into the Internet site to retrieve the video and/or still photos 414.

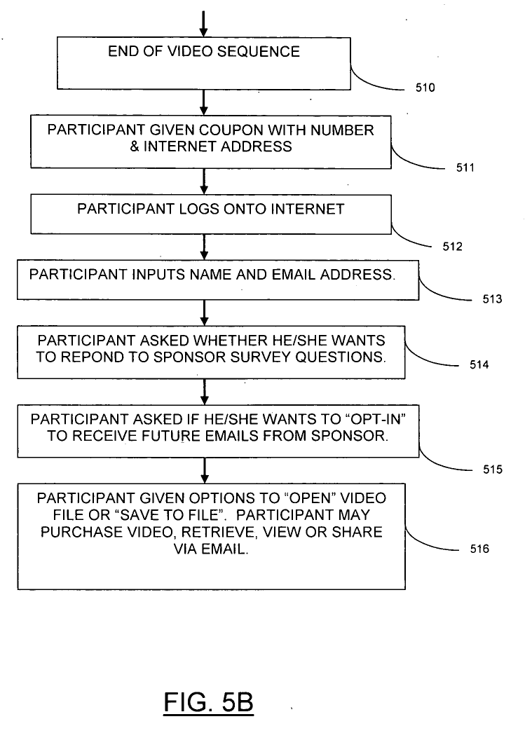

FIGS. 5A and 5B illustrate an embodiment of the invention where the participant is greeted by a celebrity on a busy street. It will be appreciated that the celebrity may be the spokesperson for the photo event sponsor. The sponsor's logo may also appear in the foreground or background image. In another embodiment, not illustrated, the sponsor's product may be shown in the video or the sponsor's services may be stated in the audio dialogue of the video.

The invention as illustrated in FIGS. 5A and 5B begins with a volunteer participant standing off-screen (understood to be out of camera range directed at a green screen) 501. The video sequence is started 502 and the pre-recorded substitute background is inserted or substituted for the green screen 503. In the illustration, the background is of a busy street scene with moving pedestrians and cars. The audio may include typical street sounds such a honking horns, etc. The pre-recorded foreground is also inserted showing a celebrity spokesperson appearing to be walking along the street into the camera view 504. The celebrity appears to see the participant and speaks. The participant, either by verbal prompt or in response to viewing a display of the combined images, moves into the camera view 505. The participant initially appears to be walking up to the celebrity and somewhat behind the celebrity in relation to the background 506 & 507. This ordering is determined by the ordering of the pixels of each separate image as previously discussed.

In the embodiment illustrated, an element of the foreground (containing the celebrity) is moved to the background such that the celebrity appears behind the participant with the celebrity's arm extending behind the back of the participant 508. The movement of the foreground image to the background is seamless to the viewer. The celebrity speaks and the participant speaks in response 509. The video sequence ends 510.

The participant is then provided means to access the composite video, illustrated to be a coupon with a number and Internet address 511. Not illustrated are the separate steps of integrating and recording the images into a video containing the composite image. The participant logs into the Internet web site 512 imputing the access number. The participant is prompted to enter his name and email address 513. The participant is then asked whether he/she wants to respond to sponsor survey questions 514. These questions may relate to the sponsor's products or services and the participant's use or preference regarding the products or service.

The participant is then asked whether he/she wants to “opt-in” to receive further emails from the sponsor 515. These emails may comprise promotional offers for the products or services, etc. The participant is also provided an opportunity to open and view the recorded composite video-or save the video image to a computer file 516. The participant may also have the opportunity to email the video to others.

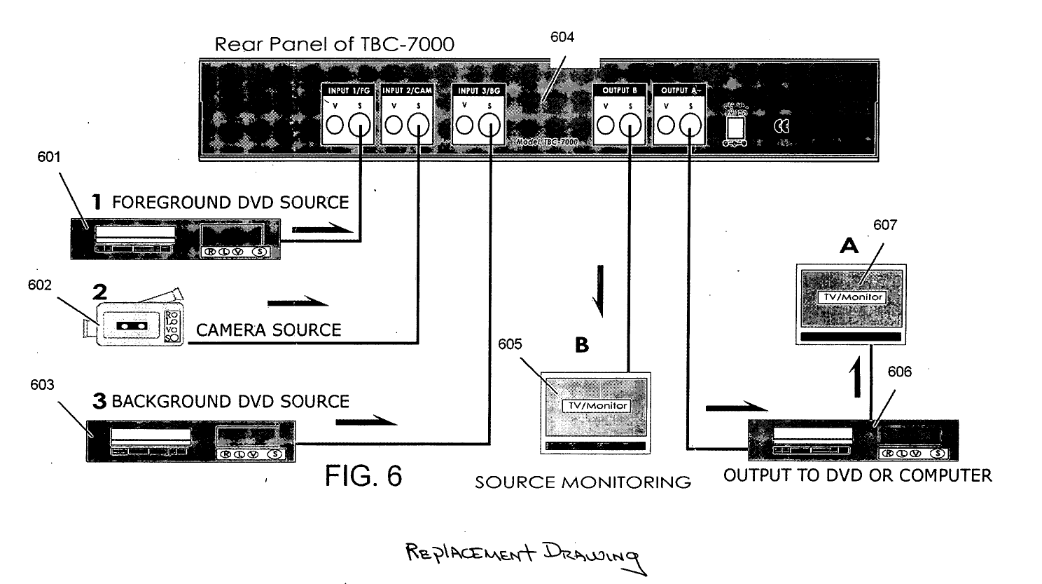

FIG. 6 illustrates another embodiment where multiple substitute images may be rendered with a photographed image of the participant positioned in front of a green screen. The foreground DVD source 601 (or input 1) is the foreground image which has been prerecorded against a green screen. The camera source 602 (input 2) is the photographed image of the participant before a green screen. The background DVD source 603 (input 3) is an additional prerecorded image. The operation of foreground and background DVD sources or inputs may be synchronized. The composite image generator 604 (a commercially available TBC 7000 manufactured by Data Video) renders the multiple input images and produces out that may be sent to a display 605 for previewing and to a CPU or DVD 606 for storage and/or display 607,

Continuing with the detailed description of the invention, audio can be utilized, both in the pre-stored images used for creating the composite images and audio of the participant perhaps singing or otherwise interacting with the one or more images of the composite.

The action of the participant in responding to action of the substituted images can be entertaining to the participant, the audience during the photography and to persons viewing the recorded image or images. This entertaining function may be motivation for the participant to later log into an Internet site or other computer network to view or retrieve the recorded images, i.e., the video or still photographs.

The novel use of chroma-key photography taught by the invention enhances the entertainment value, thereby increasing the number of participants and on-lookers. This increases exposure for the photo event sponsor or the goods or services of the sponsor. The increased number of participants increases the subset of participants who may log into the identified Internet site or other computer network (e.g. photo kiosks) to view or retrieve the video or additional photos.

This logging in gives the sponsor an opportunity to market to the participant, i.e., the participant receives information regarding the sponsor or the sponsor's products or services. Logging in also provides the sponsor an opportunity to solicit information of the participant's preferences, obtain participant reaction to new products or marketing strategies, etc.

The novel and high quality and personalized photo images which will be received by the participant in exchange for logging in will be an additional incentive and create a larger subset of participants opting in to the sponsor's site. Therefore the invention increases the total number of participants and increases the percentage of participants that will log into the sponsor's Internet website or other network site.

Of course, the entertainment provided to the audience of onlookers at the photo event may also create a larger target audience for the photo event sponsor.

The background or other objects within the view of the camera may contain the identity of the sponsor, the identity of the events where the photography is being made, i.e., sport event or venue, or the identity of the products or services of the event sponsor. The identity of the event or venue may be motivation for the participant to logging in to an Internet site to view or retrieve the recorded images. For example the participant may want one or more images as a souvenir of attending “X” theme park or “Y” sporting event.

In one variation of the invention, the interactive composite image may be recorded with a high resolution digital video camera. The participant may receive a still photo created from the recorded video image or from a separate camera. The still photo can be created at the photo event. The photo may also contain means of access to the recording via an Internet or other computer network such as a domain name, URL address, PIN, password, and/or access code where the participant can opt into to view the full video. The access code may comprise a PIN or password, user name, or participant's email address. The participant may be able to create additional still photos, e.g., the funniest moments or images, from the video or down load the entire video.

The invention also comprises a method of collecting information from one or more persons, typically participants of the photo event. Particularly, the invention includes requesting information at the time the participant logs onto a computer network or Internet to retrieve the participant'recorded image created utilizing interactive chroma-key technology of one or more pre-recorded action images. It will be appreciated that the participant is consciously logging onto a network or Internet. The participant is taking a further separate act apart from participation in the photo event. The participant therefore will likely be more favorably inclined to respond to a survey questionnaire than a randomly selected person. Therefore the response rate should be higher and the thoughtfulness of responses and thereby accuracy of collected information will be increased. By creating an entertaining photo event, the number of participants in the event will increase, thereby increasing the number of participants who may elect to separately log into the network or Internet. This will increase the population of possible “response contributors”.

The invention also includes a survey comprised of responses from photo event participants. Again, this survey includes responses from a plurality of participants who have a greater inclination to provide thoughtful responses. The percentage of persons agreeing to be response contributors from the group contacted by this method will be significantly higher than the percentage of persons agreeing to participate when randomly selected from the general population. This will increase the efficiency of survey taking and avoid negative responses or loss of the good will of people who object to unsolicited requests for information.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

What I claim is:

1. A survey response comprising responses to questions wherein a response contributor is provided access to a digitally recorded interactive chroma-key composite photo event.

2. The survey response of claim 1 wherein the response contributor responds to questions through an Internet or other computer network.

3. The survey response of claim 2 wherein the Internet or other network is identified to the response contributor at the composite photo event.

4. The survey response of claim 1 wherein the responses relate to the response contributor's preferences.

5. The survey response of claim 1 wherein the responses relate to the response contributor's personal information.

6. The survey response of claim 1 wherein the responses relate to the response contributor's opinions.

7. The survey response of claim 1 wherein the response contributor is a participant in the photo event.

8. A survey comprising a plurality of survey responses wherein at least one response contributor is solicited through an interactive chroma-key composite photo event.

9. A method of conducting a survey comprising the steps of:
a. conducting an interactive chroma-key composite photo event;
b. creating a rendered image;
c. making the rendered image available to potential response contributors; and
d. soliciting information from the potential response contributors accessing the provided image.

10. The method of claim 9 wherein the response contributors comprise at least one interactive chroma-key composite photo event participant.

11. The method of claim 9 further comprising the rendered image is provided and information is solicited through an Internet or other network.

12. A method of conducting a survey comprising the steps of:
a. conducting an interactive chroma-key composite photo event; and
b. soliciting information from the potential response contributors accessing the provided image.

13. A method of marketing products or services comprising the following steps:
a. conducting an interactive chroma-key composite photo event;
b. creating rendered image from a composition of images;
c. providing the rendered image to participants to through an Internet site or other network containing information regarding products or services.
